(19) United States
(12) Patent Application Publication
(10) Pub. No.: US 2009/0208357 A1
(43) Pub. Date: Aug. 20, 2009

(54) Rotary gear pump for use with non-lubricating fluids

(76) Inventor: Richard H. Garrett, Houston, TX (US)

Correspondence Address: ALWORTH LAW & ENGINEERING, 505 CUMBERLAND ROAD, TYLER, TX, 75703-9324, US

(21) Appl. No.: 12/070,028

(22) Filed: Feb. 14, 2008

(51) Int. Cl. F04C 2/18; B23P 15/14

(52) U.S. Cl. 418/152; 418/206.9; 29/888.023

(57) ABSTRACT

An improved external rotary gear pump for use with non-lubricating fluids such as amine is disclosed. The device uses specially coated internal parts chosen to reduce friction and improve wear characteristics so that the resulting pump will operate for a minimum warranty period of one year.

### TECHNICAL FIELD OF THE INVENTION

This invention relates to the pump industry particularly to the segment known as rotary pumps and in particular to external gear pumps although the principals disclosed may find application with internal gear pumps.

### BACKGROUND OF THE INVENTION

External gear pumps are a popular pumping principle and are often found in lubrication pumps in machine tools, in fluid power transfer units, and as oil pumps in engines. The fluid being pumped acts to supply the necessary lubrication to the pump.

External gear pumps can come in single or double pump configurations with spur, helical, and herringbone gears. Helical and herringbone gears typically offer a smoother flow than spur gears, although all gear types are relatively smooth. Large-capacity external gear pumps typically use helical or herringbone gears. Small external gear pumps usually operate at 1750 or 3450 rpm and larger models operate at speeds up to 640 rpm. External gear pumps handle viscous and watery-type liquids, but the rotary speed must be properly set for thick liquids, and it is known that reduced speeds with high-viscosity liquids results in greater efficiency.

The design of external gear pumps allows them to be made to close tolerances. Tighter internal clearances provide for a more reliable measure of liquid passing through a pump and for greater flow control. Because of this, external gear pumps are popular for precise transfer applications involving polymers, fuels, and expensive liquids.

Internal gear pumps are well-suited for a wide range of viscosity applications because of their relatively low speeds. This is especially true where suction conditions call for a pump with minimal inlet pressure requirements.

For each revolution of an internal gear pump, the gears have a fairly long time to come out of mesh allowing the spaces between gear teeth to completely fill and not cavitate. Internal gear pumps successfully pump viscosities above 1,320,000 cSt/6,000,000 SSU and very low-viscosity liquids, such as liquid propane and ammonia. In addition, lower speeds and low inlet pressures provide for constant and even discharge despite varying pressure conditions.

In addition to superior high-viscosity handling capabilities, internal gear pumps offer a smooth, nonpulsating flow. Internal gear pumps are self-priming and can run dry until the fluid starts to move. But, as in external gear pumps, the fluid being pumped must act to supply the necessary lubrication to the pump. Because internal gear pumps have only two moving parts, they are reliable, simple to operate, and easy to maintain. They can operate in either direction which allows for maximum utility with a variety of application requirements. However, unlike external gear pumps, they do not offer precise transfer applications and find little application for polymers, fuels, and expensive liquids.

Rotary pumps can be constructed in a wide variety of materials and by precisely matching the materials of construction with the liquid superior life cycle performance will result.

External gear pumps in particular can be engineered to the exact need of corrosion-resistant pumps. By using readily-available materials such as Ryton®, Ultimet®, Viton®, stainless steel, and other materials, external gear pumps can be constructed to perform very well in corrosive liquid applications. For example, composite external gear pumps can handle Acetone, Sulphuric Acid, Tomato Juice, Zinc Chloride, and hundreds of other corrosive liquids providing the fluid being pumped provides required lubrication and cooling to the pump internals.

External gear pumps are the most common type of pump in the process industry. This is because of their simplicity, reliability, and very high power ratings and because the speed of the pump may be controlled to meter a precise quantity of fluid into the process. Further more the maximum operating pressure lies between 1000 and 4000 psi (lbf/in²).

For example, in natural gas processing the gas must be dehydrated before it is sold into a pipeline for use by industry or the consumer. The standard technique involves the use of Glycols, having high boiling point and affinity for water, which are employed as liquid desiccant for the dehydration of natural gas.

The most popular glycol is Triethylene glycol (TEG, or triglycol) which is a trimer of ethylene glycol, with the formula HO—CH₂—CH₂—O—CH₂—CH₂—O—CH₂—CH₂—OH.

Essentially in a gas processing plant TEG is injected into the untreated gas and passed to a distillation tower so that dry hydrocarbon gases exit from the top of the tower and “wet” TEG is drawn from the bottom. The wet-TEG mixed is heated to drive the water away from the TEG and the “dry” TEG is recirculated to the process.

The industry can use standard piston pumps with pulsation dampers as the prime mover for TEG in the dehydration process; however, these pumps are large and expensive to maintain. For years it was understood that external gear pumps could not be used in TEG service. TEG has such poor lubrication properties; nonetheless, industry has found that carefully crafted external gear pumps may be used in TEG service. These pumps must be manufactured with extreme care as to clearances and as to choice of materials. Rotor-Tech®, Inc. has developed such pumps and external gear rotary pumps are available which will operate for reasonable periods in this service. In fact, a specially designed pump system called ‘an energy exchange pump’ (U.S. Pat. No. 4,511,378 to Greene) actually serves to inject the “dry” TEG into the process taking its drive energy from the TEG and wet gas. It is manufactured and sold by Rotor-Tech, Inc.

These energy exchange pumps, which were developed in early 1981, led to the development of an electrically driven high efficiency TEG pump which was placed on the market in December 1984. The TEG pump utilizes highly polished surfaces in order to obtain its high reliability.

Inventor Garrett further improved energy exchange pumps as disclosed in U.S. Pat. No. 5,492,556 entitled “Liquid-Gas Contacting Pump Drive Apparatus and Method.” In the Garrett improvement, an electric ‘make-up’ drive motor is added to the pump system wherein the excess wet gas (required to produce sufficient pressure drop across the drive side of the pump system) is no longer vented to the atmosphere. This is accomplished by no longer requiring a pressure drop and ‘making-up’ the energy by an electric drive.

The natural gas industry is now demanding that a rotary gear pump, similar to Rotor-Tech's line of TEG rotary external gear pumps be developed for amine service. Amines are organic compounds and a type of functional group that contain nitrogen as the key atom. Structurally amines resemble ammonia, wherein one or more hydrogen atoms are replaced by organic substituents such as alkyl and aryl groups. An important exception to this rule is that compounds of the type RC(O)NR₂, where the C(O) refers to a carbonyl group, are called amides rather than amines. Amides and amines have different structures and properties, so the distinction is chemically important.

The gas industry uses varying forms of amines such as aqueous monoethanolamine (MEA), diglycolamine (DGA), diethanolamine (DEA), diisopropanolamine (DIPA) and methyldiethanolamine (MDEA) for removing carbon dioxide (CO₂) and hydrogen sulphide (H₂S) from natural gas streams and refinery process streams. They may also be used to remove CO₂ from combustion gases/flue gases and may have potential for abatement of greenhouse gases.

Unfortunately amines have even poorer lubrication properties than glycols and rotary gear pumps will wear rapidly when used in amine service. As stated above, gear pumps are far more reliable, cheaper to install, and operate when compared to standard piston and plunger pumps and the need for better operation is driving the industry. Thus, it is an objective of this invention to provide an external rotary gear pump that will operate in amine service for a minimum of one year (the standard warranty period for Rotor-Tech pumps); thereby fulfilling a need in the industrial marketplace.

There have been attempts to produce gear pumps for amine service, however as stated earlier the service life was extremely short because the drive and idler gears would wear prematurely. Thus, the industry currently uses plunger pumps which are somewhat unreliable.

Some attempts have been made to use gear pumps in amine service, but the driven gear/idler gear system was not used. These pumps used a second set of drive gears that synchronized the two pumping gears so that, although the teeth intermeshed, there was no drive force exchanged between the pumping gears. Such an example may be found in U.S. Pat. No. 5,364,250 which discloses an “oil-free screw compressor and method of manufacture.” The amine gear pumps used in the past used gears rather than the lobes of '250 patent.

There is little guidance in the prior art when it come to pumping non-lubricating fluids. U.S. Pat. No. 6,206,667 to Turner, Jr. et al. discloses a “pump for dispensing resins.” Turner teaches the use of coated gears to prevent seizing in gear pumps used in resin service as a result of curing of the resin between the gears. Turner discloses a pump in which any part that comes in heated contact with another part is coated in various materials in order to prevent curing of the pumped resin.

U.S. Pat. No. 5,993,183 to Laskaris et al. discloses “gear coatings for rotary pumps” used for pumping foam in fire service. Laskaris preferably uses stainless steel gears each coated with a different coating—one being a Teflon®/nickel and the other being tungsten carbide/carbon. A key to the disclosure is the use of stainless steel which does not corrode in foam/water service and the lubrication of the intermeshing gears by the Teflon®/nickel coating.

U.S. Pat. No. 5,947,710 to Cooper et al. discloses a “rotary compressor with reduced lubrication sensitivity” used in HFC refrigeration compressors. Cooper uses diamond-like-carbon coating comprising alternating layers of hard and lubricious materials on the tip of a rotary compressor vane thereby reducing wear of the tip which is coacting with a piston. The key in this disclosure is the reduction in friction and improvement in wear qualities when compared with the prior art wherein additional lubrication is provided by the coating in the presence of a standard HFC lubricants. (It should be noted that a lubricant in the pumped fluid is still required.)

U.S. Pat. No. 6,079,962 to Seibel et al. discloses a “composite aluminum alloy scroll machine components” in which one of the scroll components is impregnated with graphite to improve internal lubricity.

U.S. Pat. No. 5,181,844 to Bishop et al. discloses a “rotary vane pump with carbon/carbon vanes” in the form of a sliding vane rotary pump utilized in aircraft. In the disclosure the vane comprises a plurality of layers manufactured from carbon or carbon fiber. In an alternate the vane is impregnated with Teflon®.

U.S. Pat. No. 6,688,867 to Suman et al. discloses a “rotary blower with an abradable coating” for use in Roots type rotary blowers. The coating is employed on at least one of the pump lobes and comprises a mixture of a coating matrix and a solid lubricant. The resulting coating is defined as having a “pencil hardness” ranging between 2H and 4B which is relatively soft when compared to the coatings used in other pumps.

U.S. Pat. No. 5,190,450 to Ghosh et al. discloses a “gear pump for high viscosity materials” such as cellulose acetate which discloses coated shafts operating within ceramic bearings. The action of high viscosity materials increases the loading on shafts and bearings which in the prior art resulted in premature wear.

### SUMMARY OF THE INVENTION

The instant invention comprises the standard casing employed in a Rotor-Tech external gear pump including standard “DU-Bushings” (essentially a sintered bronze bearing with lead and TFE which is manufactured by the Garlock Company) found in its TEG pumps. A high quality alloy steel (such as carburized 8620) is used in the drive gear and shaft and in the idler gear (similar to the TEG pumps); however, these particular rotating parts are face coated with high technology materials such as “Tungsten-Carbide-Carbon” (WCC) or “Diamond-Like-Carbon” (DLC) in order to provide, the necessary resistance to wear or a propriety combination of the two ceramics. A secondary benefit is that these coatings offer a low coefficient of friction between the meshing gears thereby making up for the poor lubricating properties of amines.

The intermeshing gears interact with a pressure wear plate manufactured from WCC coated bronze. The pressure wear plate backup is chosen from nylon, HDPE or a polymer which will completely resist the amine solution. Remaining parts in the device, such as seals, are chosen from materials that resist the effects of amines (for example Kalrez®).

### BRIEF DESCRIPTION OF THE DRAWINGS

FIG. 1 is an exploded view of a general external gear pump without pressure wear plates.

FIG. 2 is an end-on view of an external gear pump showing fluid flow through the gears of the pump.

FIG. 3 is a side view of the instant invention showing all parts but the case head bolts used to join the case together.

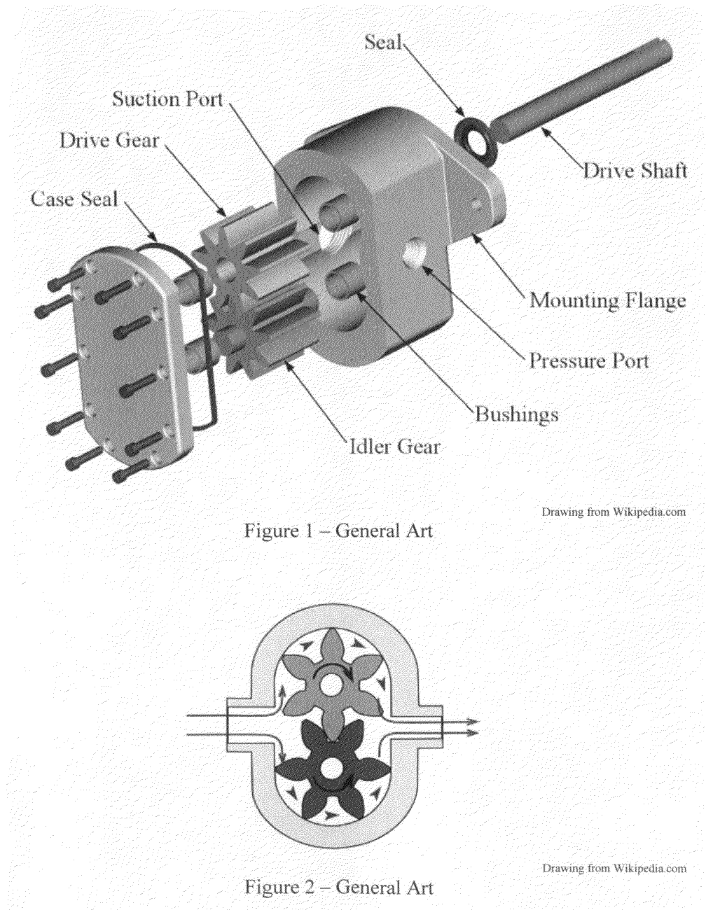

### DESCRIPTION OF THE PREFERRED EMBODIMENT

The inventor serves as the CEO of Rotor-Tech®, Inc. which manufactures an external rotary gear pump for use with a low-lubricating fluid such as glycol. In particular, the inventor was the engineer who oversaw the development of the manufactureable device covered by U.S. Pat. No. 4,511,378 to Greene and has added innovations to the industry in his U.S. Pat. No. 5,492,556. With the success of the Greene device in TEG service, in the early 1980's, and the development of the electrically driven TEG pump in the mid-1980's, the present inventor realized that an amine gear pump would be very useful.

The inventor realized that, as with TEG, amine provided little lubrication to the mechanical moving parts in a gear pump and therefore some method of wear control would be necessary. The inventor experimented with Titanium Nitride (TiN) coatings on 8620 carburized alloy steel. Unfortunately, this coating was highly susceptible to shock which made the coating fall away from the steel. The mere action of one gear operating against another is a ‘shocking’ situation and this coating technique had to be abandoned. (It should be understood that TiN could only be coated in microscopic layers and this probably lead to the “shock” problem.)

As time went by the inventor kept trying with new technology as the technology was developed. Recently diamond-like-carbon (DLC) has been introduced to the marketplace of ideas along with other surface hardeners such as tungsten-carbide-carbon (WCC). These particular coatings allow for a thicker coating and are much more ‘friendly’ in gear service.

A plurality of standard TEG pumps, manufactured by the inventor's small business were modified. The drive gear and shaft and the idler gear and shaft of several pumps were coated with WWC, and the drive gear and shaft and idler gear of several other pumps were coated with DLC. In all cases the wear plate was coated with WCC. A plurality of pumps were assembled and sent into the field for field tests (at the time of this disclosure) for nine months of testing. So far the pumps have preformed within specification; however the prototype pumps failed within 4 months because improper drive shaft seals were utilized.

Several pumps were manufactured and tested using WCC on the drive and DLC on the idler and vice-versa. It is believed that the results will be better as the coefficient of friction between dissimilar materials is lower than between similar materials. More recently pumps are being manufactured using a propriety dual coating which combines DLC over WCC. This particular coating is provided by the IonBond Company under the tradename TRIOBOND 41. Thus it has been discovered that similar coatings work as well, if not better than, dissimilar coatings in amine service.

A series of test were conducted to determine the best set of seals for the drive shaft and the casing. These tests showed that 734-10% carbon graphite-TFE, X484—mineral filled TFE or Kalrez®, manufactured by DuPont, would perform as both a seal for the drive shaft and casing. The preferred pressure wear plate backup was found to be a nylon product. (Although HDPE and certain polymers would perform well.) A further pressure wear plate was found to be an antimony filled graphite carbon matrix. The base steel for the gears was preferred as 8620 carburized alloy steel. As noted above there was a drive seal failure after 3-4 months in the prototype pumps due to one of the seals being manufacture from a polymer that was incompatible with amines. This problem was resolved by using Kalrez®.

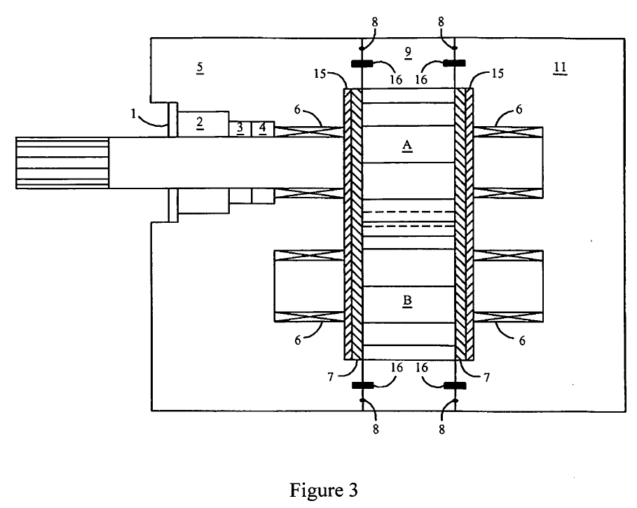

Turning now to FIG. 3 which is a diagrammatic side view of the instant invention. The rotary gear pump of the instant invention is enclosed in a split housing comprising a first part, 5, a middle section, 9, and an end cap, 11. The drive motor (not shown) is mounted to the first section, 5. Within the first section may be found a standard snap ring, 1, which holds the drive gear and seals in place in the case, 5. Following the snap ring, 1, may be found the seal back up, 3, and the shaft seal, 4. The plurality of “DU-bushings”, 6, is shown which support the drive shaft and drive gear, A, and the idler gear/shaft, B. The casing seals, 8 are shown as well as the dowel pins, 16, which make certain that the alignment, of the casing sections, is correct. The pressure wear plates, 7, are shown along with their associated pressure wear plate backups, 15, which actually force the wear plate against the sides of gears by reacting with the casing. The wear plates are designed so that the pump output pressure forces the wear plates against the gears.

The bushings, 6, are standard Garlock DU® Bushings. These bushings are manufactured from sintered bronze power impregnated with lead and TFE—a lubricant! The driven combination gear and shaft, A, are manufactured as one piece as is the idler gear and associated shaft, B. (Although a two-part system may be employed—i.e., a drive shaft fitted into the drive gear.)

The driven gear and shaft, A, and idler gear, B, are manufactured from, preferably 8620 carburized alloy steel which is then carburized to a high hardness and a surface polished to approximately one-micro inch (or better). Each of these gear parts is coated with a surface hardener which is chosen from WCC or DLC (for example Balinit® DLC supplied by Oerlikon Ag. of Switzerland) or now preferably with DLC over WCC (for example Tribobond 41™ supplied by IonBond Ag. of Switzerland). It has been found that the drive and idler gears should be carefully pre-cleaned prior to depositing the coating and a post coating rust preventative solution may be applied to the gears.

Currently the pressure wear plate, 7, which is in contact with the gears, is coated with WCC and made from standard bronze. Other materials which exhibit high wear characteristics are under consideration.

The choice of the pressure wear plate backup (which operates to exert the required force against the gear sides) is manufactured from vydyne nylon. It has been discovered that HDPE and other polymers may be substituted provided those polymers will hold up in amine service. Kalrez® is a polymer that will hold—in the face of anything!

The rotary pump described above may be used in an energy exchange pump system or preferably in an electric drive system. The thoughts and inventive steps behind a rotary gear pump that may be utilized in pumping a fluid with little or no lubrication properties have been disclosed. The design principles stress external gear pumps; however, the principles may be applied to internal gear pumps.

Currently improved pumps utilizing the techniques given in this disclosure are in service and are providing known service times of 6-9 months. It is expected that these pumps will provide service periods of 9-12 months, with 12 months being the target. Twelve months is the standard warranty period offered by the current manufacture and assignee. It is known that the service life of the improved amine pumps will be set by the quality of amine, service pressure and other operating conditions such as temperature.

I claim:

1. An Improved Rotary Gear Pump for preferable use with non-lubricating fluids comprising:
a split housing adapted to enclose a driven gear with a drive shaft and an intermeshing idler gear wherein each of said gears has sides perpendicular to the intermeshing portion of said gears;
wherein said housing is further adapted to retain a plurality of bushings for providing a bearing means for said driven gear and drive shaft and said idler gear;
a pair of pressure wear plates having a first side and a second side adapted to exert pressure against said sides of said gears;
an associated set of pressure wear plates backups adapted to exert pressure against said second side of said pressure wear plate and said split housing so that each of said first side of said pressure wear plates exert a force against said sides of said gears;
a shaft seal and retaining means adapted to seal said drive shaft within said split housing and to further retain said driven gear and drive shaft within said housing;
a split case sealing means;
wherein said drive gear and drive are surface coated with a first hardening material;
wherein said idler gear is surface coated with a second hardening material; and,
wherein said first side of said pressure wear plate is surface coated with a third hardening material.

2. The device of claim 1 wherein said first, second and third hardening materials are tungsten-carbide-carbon.

3. The device of claim 1 wherein said first and second hardening material is diamond-like-carbon and said third hardening material is tungsten-carbide-carbon.

4. The device of claim 1 wherein said first hardening material is diamond-like-carbon and said second and third hardening material is tungsten-carbide-carbon.

5. The device of claim 1 wherein said first and second hardening material is a combination comprising first tungsten-carbide-carbon over which a diamond-like-carbon is placed and said third hardening material is tungsten-carbide-carbon.

6. The device of claim 1 wherein said first and second hardening material is BALINIT® DLC.

7. The device of claim 1 wherein said first and second hardening material is TRIOBOND 41™.

8. The device of claim 1 further comprising drive shaft sealing means between said housing and said drive shaft wherein said drive shaft sealing means is a KALREZ® o-ring assembly

9. The device of claim 1 wherein said split case sealing means is a KALREZ® o-ring.

10. An Improved Rotary Gear Pump for preferable use with non-lubricating fluids comprising:
a split housing adapted to enclose a driven gear with a drive shaft and an intermeshing idler gear wherein each of said gears has sides perpendicular to the intermeshing portion of said gears;
wherein said housing is further adapted to retain a plurality of bushings for providing a bearing means for said driven gear and drive shaft and said idler gear;
a pair of pressure wear plates having a first side and a second side adapted to exert pressure against said sides of said gears;
an associated set of pressure wear plates backups adapted to exert pressure against said second side of said pressure wear plate and said split housing so that each of said first side of said pressure wear plates exert a force against said sides of said gears;
a shaft seal and retaining means adapted to seal said drive shaft within said split housing and to further retain said driven gear and drive shaft within said housing;
a split case sealing means;
wherein said drive gear and drive are surface coated with a first hardening material;
wherein said idler gear is surface coated with a first hardening material;
wherein said first side of said pressure wear plate is surface coated with a second hardening material and,
wherein said first hardening material is a combination comprising first tungsten-carbide-carbon over which a diamond-like-carbon is placed and said second hardening material is tungsten-carbide-carbon.

11. The device of claim 10 wherein said first and second hardening material is TRIOBOND 41™.

12. The device of 10 wherein said split case seal means and said drive shaft seal is a KALREZ® o-ring.

13. A method of manufacturing pump gears for use in rotary gear pumps for handling non-lubricating fluids and having a driven gear and an idler gear comprising:
a. manufacturing said drive gear and said idler gear from alloy steel;
b. pre-cleaning said drive and idler gears; and
c. coating said drive and idler gears with the same wear resistant low friction coating.

14. The method of manufacture of method 13 wherein said alloy steel is 8620 carburized alloy steel.

15. The method of manufacture of method 13 wherein said wear resistant low fiction coating is tungsten-carbide-carbon.

16. The method of manufacture of method 13 wherein said wear resistant low fiction coating is diamond-like-carbon.

17. The method of manufacture of method 13 wherein said wear resistant low fiction coating is a combination of tungsten-carbide-carbon and diamond-like-carbon.

18. The method of manufacture of method 16 wherein said diamond-like-carbon coating is BALINIT® DLC.

19. The method of manufacture of method 17 wherein said combination coating is TRIOBOND 41™.

20. The method of manufacture of method 13 wherein the following step follows step (c)
d. applying a rust preventative solution.
